(19) United States
(12) Patent Application Publication
(10) Pub. No.: US 2019/0041140 A1
(43) Pub. Date: Feb. 7, 2019

(54) HEAT EXCHANGER

(71) Applicant: Valeo Systemes Thermiques, Le Mesnil Saint Denis (FR)

(72) Inventors: Issiaka Traore, Courbevoie (FR); Kamel Azzouz, Paris (FR)

(73) Assignee: Valeo Systemes Thermiques, Le Mesnil Saint Denis (FR)

(21) Appl. No.: 15/754,677

(22) PCT Filed: Aug. 2, 2016
(86) PCT No.: PCT/EP2016/068423

§ 371 Date: Oct. 23, 2018

(30) Foreign Application Priority Data
Aug. 25, 2015 (FR) 1557906

(51) Int. Cl. F28F 3/04; F02B 29/04

(52) U.S. Cl. CPC F28F 3/046; F28F 3/027; F02B 29/0456

(57) ABSTRACT

The present invention relates to a heat exchanger comprising:
a multiplicity of flat tubes (2) positioned parallel to one another, in which a first fluid flows,
spacers (3) positioned between said flat tubes (2), said spacers (3) having a periodic profile whose ends (30) are in contact with the outer surfaces of said flat tubes (2), said spacers (3) having a second fluid flowing through them,
   the flat tubes (2) comprising grooves (20) on their outer surfaces, the ends (30) of the spacers (3) and said grooves (20) having a complementary shape and length, such that said ends (30) of the spacers (3) are inserted into said grooves (20).

The invention relates to a heat exchanger, particularly for a motor vehicle.

Heat exchangers, notably in the motor vehicle field, are usually composed of flat tubes grouped in a bundle, between which spacers are positioned. A first fluid, for example; a heat transfer fluid such as glycol/water or a gas, flows inside the flat tubes, and a second fluid, for example air, flows between said flat tubes through the spacers. The flat tubes may take the form of stacked elongated tubes, or alternatively pairs of plates inside which a circuit for the flow of the first fluid is formed. The exchange surface between the first and the second fluid is increased by the presence of the spacers, but the thermal conductivity between these two fluids is also affected by the quality of the thermal bridge between these spacers and the flat tubes. If there is not a good thermal bridge at the contact between the spacers and the flat tubes, the heat exchanger will be less efficient.

One of the objects of the present invention is therefore to overcome at least some of the drawbacks of the prior art, and to propose an improved heat exchanger.

The present invention therefore relates to a heat exchanger comprising:
a multiplicity of flat tubes positioned parallel to one another, in which a first fluid flows,
spacers positioned between said flat tubes, said spacers having a periodic profile whose ends are in contact with the outer surface of said flat tubes, said spacers having a second fluid flowing through them,
   the flat tubes having grooves on their outer surfaces, the shapes and lengths of the ends of the spacers and said grooves being complementary, such that said ends of the spacers are inserted into said grooves.

The presence of these grooves can facilitate the assembly of the bundle by providing a housing into which the ends of the spacers may be inserted. These grooves also improve the contact between the outer surface of the flat tubes and the spacers, thereby improving the heat exchange between these two elements. Because of these grooves, the performance of the heat exchanger according to the invention is better than that of others of equivalent size.

According to an aspect of the invention, the ends of the spacers have the profile of a continuous line over the whole width of the flat tubes, and a groove on the outer surface of the flat tubes forms a single continuous line over the width of said flat tube.

According to another aspect of the invention, the spacers comprise at least two strips with a periodic profile, offset relative to one another, and, over their width, the flat tubes comprise, on their outer surfaces, segmented grooves which are complementary to the ends of the strips with a periodic profile.

According to another aspect of the invention, the grooves on the outer surface of the flat tubes also form a protuberance on the inner surface of said flat tubes. According to another aspect of the invention, the grooves and the protuberances of the two walls of the flat tubes are positioned one below the other.

According to another aspect of the invention, the grooves and the protuberances of the two walls of the flat tubes are offset relative to one another.

According to another aspect of the invention, the depth of the grooves is less than 50% of the height of the void in the flat tube, and is preferably between 40% and 30%. According to another aspect of the invention, each of the flat tubes comprises a pair of plates, inside which a circuit for the flow of the first fluid is formed.

According to another aspect of the invention, the periodic profile of the spacers is a sinusoidal profile. According to another aspect of the invention, the ends of the spacers are rounded.

According to another aspect of the invention, the ends of the spacers are flat.

According to another aspect of the invention, the periodic profile of the spacers is a crenelated profile. According to another aspect of the invention, the periodic profile of the spacers is a sawtooth profile.

According to another aspect of the invention, the flat tubes and the spacers are made of a metallic material and are fixed to one another by brazing.

Other characteristics and advantages of the invention will be more clearly apparent from a reading of the following description, provided as an illustrative and non-limiting example, and from the appended drawings, of which:

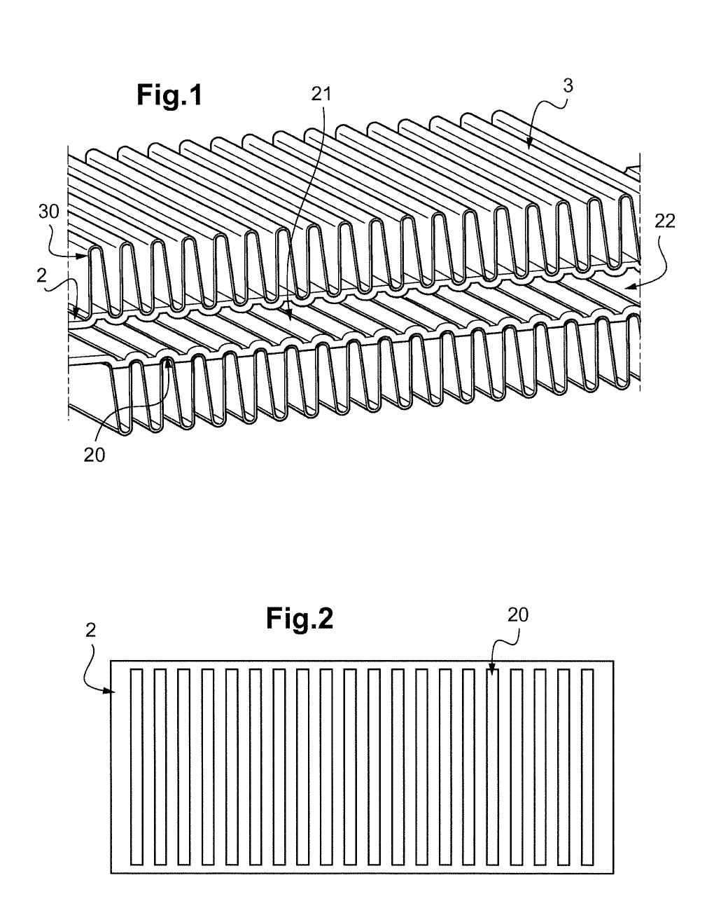

FIG. 1 is a schematic perspective representation of a flat tube comprising spacers on both of its faces according to a first embodiment,

FIG. 2 is a schematic representation, viewed from above, of a flat tube according to the first embodiment,

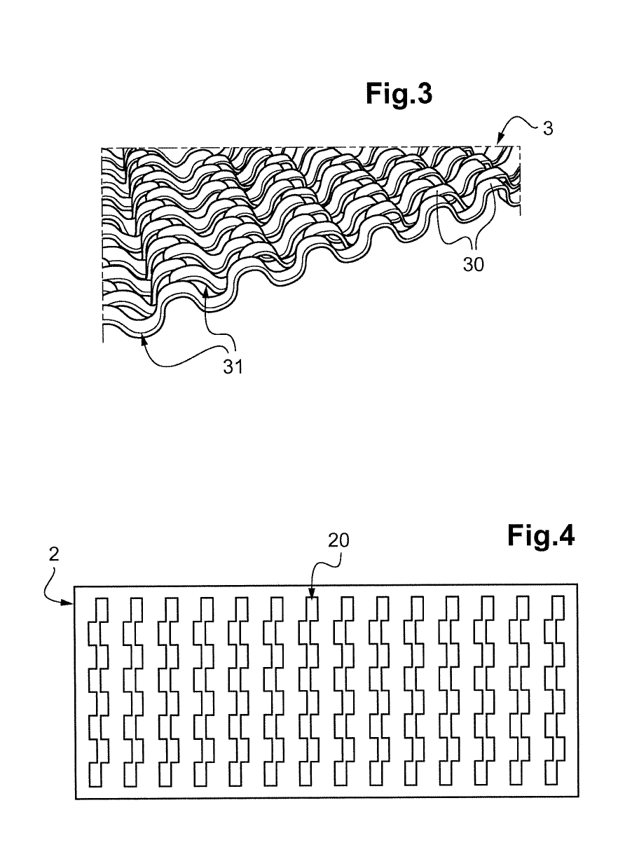

FIG. 3 is a schematic perspective representation of a spacer according to a second embodiment,

FIG. 4 is a schematic representation, viewed from above, of a flat tube according to the second embodiment,

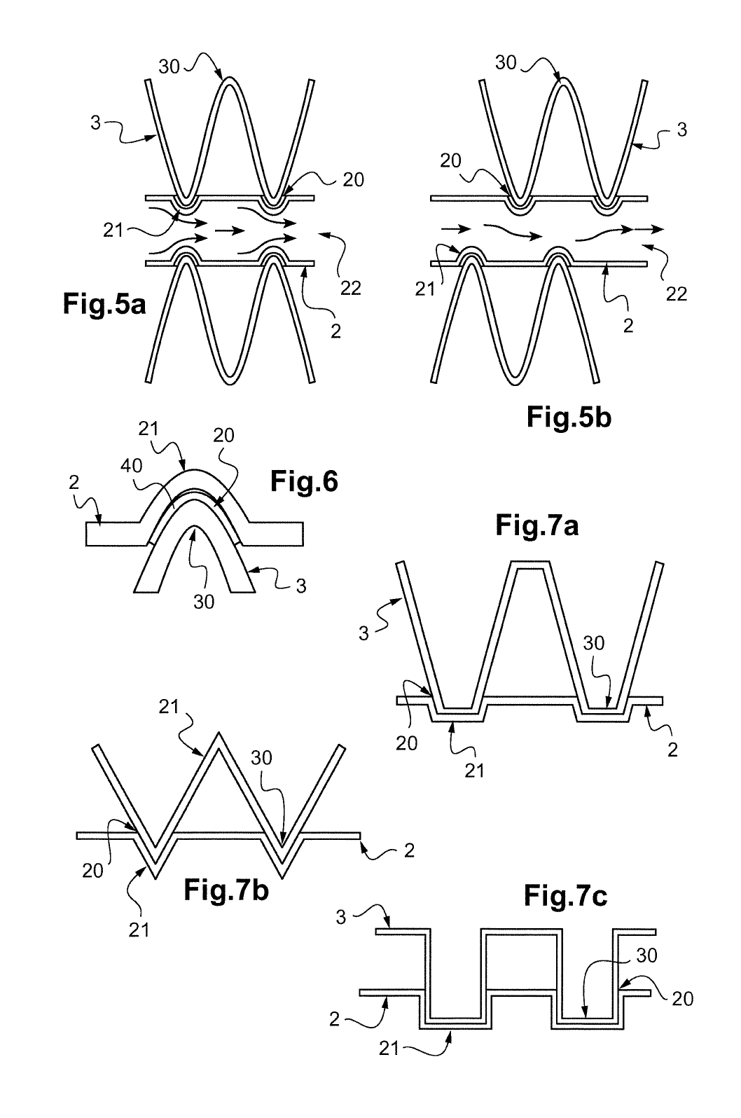

FIGS. 5a and 5b are schematic sectional representations of a flat tube comprising spacers on both of its faces according to two different embodiments,

FIG. 6 is a schematic sectional representation of the connection between a flat tube and a spacer,

FIGS. 7a to 7c are schematic sectional representations of a flat tube comprising spacers on according to alternative embodiments.

Identical elements in the various figures have been given the same references.

The following embodiments are examples. Although the description refers to one or more embodiments, this does not necessarily mean that each reference concerns the same embodiment, or that the characteristics are applicable to a single embodiment only. Simple characteristics of different embodiments may also be combined to provide other embodiments.

In the present description, some elements or parameters may be indexed, for example as a first element or second element, or first parameter and second parameter, or first criterion and second criterion, etc. In this case, this is a simple indexing for the purpose of differentiating and designating elements or parameters or criteria which are similar but not identical. This indexing does not imply that any element, parameter or criterion takes priority over another, and such designations may easily be interchanged without departing from the scope of the present invention. Furthermore, this indexing does not imply any ordering, in time for example, for the estimation of any one or other criterion.

A heat exchanger, notably in the motor vehicle field, usually comprises:
a multiplicity of flat tubes 2 positioned parallel to one another, in which a first fluid flows, and
spacers 3 positioned between said flat tubes 2.

These spacers 3 usually have a periodic profile, the ends 30 of which are contact with the outer surfaces of said flat tubes 2. Said spacers 3 have a second fluid passing through them.

The flat tubes 2 and the spacers 3 usually form a bundle, and the ends of the flat tubes are connected to manifolds of the first fluid. The flat tubes 2 may, for example, be tubes which have an oblong and relatively flat shape in cross section. They may also take the form of a pair of plates forming a circuit for the flow of the first fluid. In this case, the pairs of plates are superimposed to form the bundle, the second fluid flowing between the pairs of plates.

As shown in FIGS. 1 and 2, the flat tubes 2 have grooves 20 on their outer surfaces (the surfaces in contact with the second fluid). The ends 30 of the spacers 3 and said grooves 20 have a complementary shape and length, such that said ends 30 of the spacers 3 are inserted into said grooves 20.

The presence of these grooves 20 can facilitate the assembly of the bundle by providing a housing into which the ends of the spacers 3 may be inserted. These grooves 20 also improve the contact between the outer surfaces of the flat tubes 2 and the spacers, thereby improving the heat exchange between these two elements. Because of these grooves 20, the performance of the heat exchanger according to the invention is better than that of others of equivalent size.

As shown in FIG. 1, the ends 30 of the spacers 3 may have the profile of a continuous line over the whole width of the flat tubes 2. Thus a corresponding groove 20 on the outer surface of the flat tubes 2 forms a single continuous line over the width of said flat tube 2, as shown in FIG. 2.

On the other hand, as shown in FIG. 3, the spacers 3 may comprise at least two strips 31 with a periodic profile, offset relative to one another. Thus, as shown in FIG. 4, the flat tubes 2 comprise on their outer surfaces, over their width, segmented grooves 20 which are complementary to the ends 30 of the strips 31 with a periodic profile.

As shown more particularly in FIGS. 5a and 5b, a groove 20 on the outer surface of the flat tubes 2 also forms a protuberance 21 on the inner surface (the surface in contact with the first fluid) of the flat tubes 2. This protuberance 21 enables the first fluid to be perturbed and homogenized, thereby improving the heat exchange and consequently the performance of the heat exchanger, as a result of the turbulence created.

According to a first embodiment, the grooves 20 and the protuberances 21 of the two walls of the flat tubes 2 are positioned one below the other, as shown in FIG. 5a.

According to a second embodiment, the grooves 20 and the protuberances 21 of the two walls of the flat tubes 2 are offset relative to one another, as shown in FIG. 5b. This second embodiment provides better agitation and better homogenization of the first fluid, thereby yielding better performance.

The depth of the grooves 20, and therefore the height of the protuberances 21, is preferably less than 50% of the height of the void 22 in the flat tube 2. This depth may, notably, be between 40% and 30% of the height of the void 22 in the flat tube 2.

The flat tubes 2 and the spacers 3 are made of a metallic material and are fixed to one another by brazing. A brazing strip 40 is then present between the ends 30 of the spacers 3 and the grooves 20, as shown in FIG. 6. The periodic profile of the spacers 3 may be a sinusoidal profile, as shown in FIGS. 1 to 7a. According to a first embodiment, the ends 30 of the spacers 3 are rounded, as shown in FIGS. 1 to 6. Correspondingly, the grooves 20 also have a rounded bottom to form a suitable housing for said ends 30 of the spacers 3.

According to a second embodiment, the ends 30 of the spacers 3 having a sinusoidal profile are flat, as shown in FIG. 7a. Correspondingly, the grooves 20 also have a flat bottom to form a suitable housing for said ends 30 of the spacers 3.

According to other embodiments, the spacers 3 may have a sawtooth profile, as shown in FIG. 7b, or alternatively a crenelated profile, as shown in FIG. 7c. Regardless of the shape of the ends 30 of the spacers 3 or the profile of said spacers, the grooves 20 have a suitable and corresponding shape to form a suitable housing for the ends 30 of the spacers 3, in order to maximize the heat exchange.

Evidently, therefore, the performance of the heat exchanger is better, owing to the presence of the grooves 20 and the improved connection between the spacers 3 and the flat tubes 2.

1. A heat exchanger, comprising:
a plurality of flat tubes positioned parallel to one another, in which a first fluid flows; and
spacers positioned between each of said plurality of flat tubes, said spacers having a periodic profile whose ends are in contact with outer surfaces of said plurality of flat tubes, said spacers having a second fluid flowing through them,
wherein each of the plurality of flat tubes comprises grooves on the outer surfaces, the ends of the spacers and said grooves having a complementary shape and length, such that said ends of the spacers are inserted into said grooves.

2. The heat exchanger as claimed in claim 1, wherein the ends of the spacers have the profile of a continuous line over a whole width of the plurality of flat tubes, and wherein a groove on the outer surface of the flat tubes forms a single continuous line over the width of said plurality of flat tubes.

3. The heat exchanger as claimed in claim 1, wherein the spacers comprise at least two strips with a periodic profile, offset relative to one another, and, over the whole width, the plurality of flat tubes comprise, on their outer surfaces, segmented grooves which are complementary to the ends of the strips with a periodic profile.

4. The heat exchanger as claimed in claim 1, wherein the grooves on the outer surface of the plurality of flat tubes also form a protuberance on the inner surface of said flat tubes.

5. The heat exchanger as claimed in claim 4, wherein the grooves and the protuberances of the two walls of the flat tubes are positioned one below the other.

6. The heat exchanger as claimed in claim 4, wherein the grooves and the protuberances of the two walls of the flat tubes are offset relative to one another.

7. The heat exchanger as claimed in claim 1, wherein the depth of the grooves is less than 50% of the height of a void in the flat tube.

8. The heat exchanger as claimed in claim 1, wherein each of the plurality of flat tubes comprises a pair of plates, inside which a circuit for the flow of the first fluid is formed.

9. The heat exchanger as claimed in claim 1, wherein the periodic profile of the spacers is a sinusoidal profile.

10. The heat exchanger as claimed in claim 9, wherein the ends of the spacers are rounded.

11. The heat exchanger as claimed in claim 9, wherein the ends of the spacers are flat.

12. The heat exchanger as claimed in claim 1, wherein the periodic profile of the spacers is a crenelated profile.

13. The heat exchanger as claimed in claim 1, wherein the periodic profile of the spacers is a sawtooth profile.

14. The heat exchanger as claimed in claim 1, wherein each of the plurality of flat tubes and the spacers are made of a metallic material and are fixed to one another by brazing.
